(19) United States
(12) Patent Application Publication
(10) Pub. No.: US 2007/0113911 A1
(43) Pub. Date: May 24, 2007

(54) Multi-lumen miniature ribbon tubing

(75) Inventors: Ronald Poklemba, Marlborough, MA (US); Kenneth J. Plourde, Upton, MA (US); Kristopher B. Lower, Grafton, MA (US)

Correspondence Address: MCCORMICK, PAULDING & HUBER LLP, CITY PLACE II, 185 ASYLUM STREET, HARTFORD, CT, 06103, US

(73) Assignee: Temp-Flex Cable, Inc., South Grafton, MA (US)

(21) Appl. No.: 11/285,847

(22) Filed: Nov. 22, 2005

(51) Int. Cl. F16L 9/18

(52) U.S. Cl. 138/115; 138/116; 138/111

(57) ABSTRACT

A multi-lumen miniature ribbon tube is generally flat in overall shape, and includes a number of generally parallel, longitudinal lumens arranged sequentially. Each lumen includes a tubular polymer sidewall defining a separate longitudinal fluid passageway. (Here, “lumen” refers to a sidewall and passageway in combination.) The lumens are integrally formed, but may be frangible from one another. The sidewall may be made of FEP or ETFE. The ribbon tube may be as wide as 3.5 inches, and each lumen has a passageway diameter of 0.005 to 0.050 inches. Using minimum dimensions, a 3.5-inch wide ribbon tube has more than 200 lumens, each of which provides a separate fluid passageway. This enables a multiplicity of fluids to be delivered to one location. Additionally, because the lumens are frangible, one or more fluids may be delivered to multiple localized locations by separating the lumens proximate the tubing's end.

### FIELD OF THE INVENTION

The present invention relates to tubular conduits and, more particularly, to plural duct tubular conduits

### BACKGROUND OF THE INVENTION

For conducting fluids to and from the human body or portions thereof (e.g., for delivering liquid nutrients, medicine, or blood), flexible rubber or polymer tubing has traditionally been used. Such tubing typically comprises an elongate cylindrical sidewall defining a hollow, cylindrical passageway having a relatively wide diameter (e.g., from 0.125 to 0.250 inches) through which the fluid travels. Such tubes are well adapted to delivering large amounts of a single fluid to or from a single location, but cannot be used to concurrently deliver multiple non-commingled fluids. Multiple tubes can be used to deliver multiple fluids, but this requires bundling the tubes together to avoid a “tangle” of tubes. Also, such bundled tubes are bulky, and cannot be used in situations involving the delivery of many different fluids and/or fluids to a very small or restricted destination location, e.g., a single organ. They also present a greater risk of contamination due to the increased total surface area requiring sterilization or disinfecting.

Since conventional tubes are impractical for doing so, multi-lumen tubes and catheters are used for delivering different fluids to and from the human body or other location. As shown in FIGS. 1A and 1B, such tubes typically have a cylindrical outer wall and two or more interior lumens, i.e., separate longitudinal passageways. These tubes work well in certain applications, e.g., as catheters for delivering nutrients, but are impractical in situations where fluids have to be delivered to different locations. This is because the lumens are integral with the overall tube and, therefore, are necessarily co-terminus, i.e., have openings lying proximate to one another. This is because the lumens cannot be separated from one another.

Flat tubes or hoses have been used in certain situations where a generally flat outer shape is desired over a tubular outer shape. For example, as shown in FIG. 1C, ribbon tubes are sometimes used in applications where a “low profile” is required. Also, flat hoses are available for garden use, and are believed to be less prone to kinking then conventional round hoses. As should be appreciated, however, such devices are not suitable for delivering multiple fluids within a clinical, laboratory, or other context.

### SUMMARY OF THE INVENTION

An embodiment of the present invention relates to a multi-lumen, miniature ribbon tube. The ribbon tubing is generally flat in overall shape, and comprises a number of generally parallel, longitudinal lumens arranged sequentially one next to the other. Each lumen includes a tubular polymer sidewall defining a longitudinal fluid passageway or bore. (As used herein, “lumen” refers to a sidewall and passageway/bore in combination, while “fluid” refers to all freely flowable materials including liquids and gases.) The fluid passageways are each separated from one another by the sidewalls. The lumens are integrally formed, but may be provided with outwards-facing longitudinal grooves (upper and lower grooves between neighboring pairs of lumens) for facilitating longitudinal separation of the lumens from one another. The sidewall may be made of a medical grade Teflon®-type polymer, e.g., FEP or ETFE. The ribbon tubing may be as wide as 3.5 inches, and may have the following additional dimensions: a passageway diameter of about 0.005 to about 0.050 inches; and a minimum wall thickness of about 0.002 inches and more typically at least about 0.005 inches.

Using the minimum wall thickness and passageway diameter, a 3.5-inch wide ribbon tube according to the present invention would have well more than 200 lumens, each providing a separate fluid passageway. Tubing having a larger wall thickness and/or larger passageway diameter would have fewer lumens, but still typically at least six, and more typically at least twenty lumens. In each case, this would enable a multiplicity of fluids to be delivered to one location, a single fluid to be delivered to multiple locations, or any combination thereof. Because the distal ends of the lumens can be separated from one another, each can be directed to a different localized destination location. At the same time, the central portion of the tubing (i.e., the portion where the lumens remain connected) provides a compact, unitary tubing unit that can be easily routed without tangling, kinking, etc. Additionally, if the distal ends of some or all of the lumens are left connected together, they can be conveniently terminated into one mass, multi-lumen connector that provides a single common connection (i.e., one fluid source for all the lumens), multiple connections (i.e., different fluid sources for the different lumens), or a combination of the two.

### BRIEF DESCRIPTION OF THE DRAWINGS

The present invention will be better understood from reading the following description of non-limiting embodiments, with reference to the attached drawings, wherein below:

FIGS. 1A and 1B are cross-sectional views of prior art multi-lumen tubes or catheters;

FIG. 1C is a cross-sectional view of a prior art flat tube;

FIG. 2 is a perspective view of miniature ribbon tubing according to an embodiment of the present invention;

FIG. 3A is a cross-sectional view of the ribbon tubing of FIG. 2 taken along line 3A-3A;

FIG. 3B is a cross-sectional view of the ribbon tubing in FIG. 2 with a slightly larger pitch;

FIG. 4 is a schematic view of the ribbon tubing in use for delivering fluids, at a source end;

FIG. 5 is a perspective view of the ribbon tubing in use, at a destination end;

FIG. 6 is a cross-sectional view of an alternative embodiment of the ribbon tubing; and

FIGS. 7A and 7B are top plan views of tubing connectors.

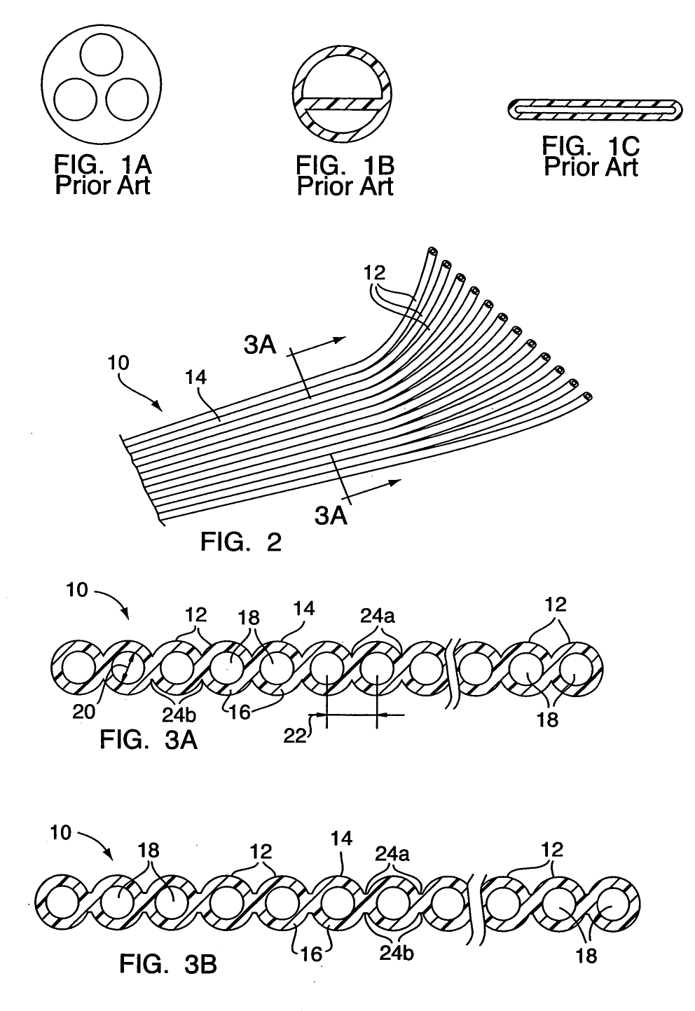

### DETAILED DESCRIPTION

With reference to FIGS. 2-5, an embodiment of the present invention relates to a multi-lumen, miniature ribbon tube 10. The ribbon tubing 10 is generally flat in overall shape, and comprises a number of generally parallel, generally tubular lumens 12 arranged sequentially one next to the other. In other words, the lumens 12 are laterally sequentially arranged in parallel to form a generally flat outer periphery 14. (By “generally flat,” it is not meant that the top and bottom of the ribbon tubing is necessarily flat or without contours/features, although that could be the case; instead, it is meant that the tubing is significantly wider than it is thick.) Each lumen 12 includes a polymer sidewall 16 and a hollow, longitudinal fluid passageway or bore 18 extending down through the center of the sidewall 16. The fluid passageways 18 will typically be separated from one another, i.e., not in fluid communication. (By “fluid,” it is meant any flowable material including liquids and gases.)

The longitudinal passageways 18 will typically be circular in cross section. However, passageways having different cross sections are possible. For example, the passageways could be elliptical or polygonal in cross section. In either case, the passageways have a maximum dimension 20, by which it is meant the maximum straight-line lateral distance across the passageway. In the case of a passageway with a circular cross section, the maximum dimension 20 is the inner diameter of the lumen, as shown in FIG. 3A. Typically, the inner diameter (or other maximum dimension) will be from about 0.005 to about 0.050 inches, where “about” refers to manufacturing tolerances typically on the order of ±1 on the least significant digit, e.g., 0.005±0.001 inches. The polymer sidewall may be as thin as about 0.002 inches, but for increased sturdiness will more typically have a thickness of at least about 0.005 inches up to about 0.015 inches. A wall thickness of more than about 0.015 inches is possible, e.g., up to a maximum of about 0.050 inches. The pitch 22 of the tubing (meaning the distance between the longitudinal axes of neighboring passageways) will typically be at least 1.5 times the maximum dimension 20. Thus, with an inner diameter 20 of about 0.005 inches, the pitch would be at least about 0.007 inches. More typically, with an inner diameter of about 0.005 inches and a wall thickness of about 0.005 inches, the pitch would be at least about 0.012 inches.

To provide for relative compactness, the ribbon tubing 10 will typically be around 3.5 inches wide or less. With an inner diameter of about 0.005 inches, a wall thickness of about 0.005 inches, and a pitch of about 0.012 inches, a 3.5-inch wide length of the ribbon tubing 10 would include at least 280 lumens 12. Because each lumen 12 defines a separate longitudinal fluid passageway 18, a length of such a tubing could be used to deliver a number of different fluids from one location to another, one fluid from one location to a plurality of different localized destination locations, or any combination thereof, all in a convenient, compact, easy-to-route, and easy-to-terminate package.

Because passageways 18 with a diameter 20 of about 0.005 inches will admit a relatively small volume of fluid, for certain applications where it is desired to transmit a greater volume of fluid, passageways with a diameter (or other maximum dimension) of from about 0.015 to about 0.050 inches may be used. For the latter, with a wall thickness of from about 0.015 to about 0.050 inches, there will be a minimum of six lumens 12 in a one inch-wide section of tubing 10. At least this many lumens in a one inch-wide section of tubing would provide an acceptable balance between flexibility in delivering one or more fluids to different locations and a compact package or overall shape. For greater flexibility in terms of fluid delivery, a 3.5-inch wide section of tubing would provide at least twenty-three of the lumens 12—still a compact overall package. With a smaller inner diameter 20 of about 0.015 inches and a wall thickness of from about 0.005 to about 0.015 inches, there would be at least twenty lumens 12 in a one inch-wide section of tubing 10. Overall, it is believed that tubing 10 with at least twenty lumens 12 in a one inch-wide section would provide an optimal balance between flexibility in delivering fluids to different locations while preserving a compact outer package/periphery.

The sidewall 16 may be made of a polymer such as a medical grade fluoropolymer or other polymer, for example FEP (fluorinatedethylenepropylene) or ETFE (ethylene-tetrafluoroethylene). Other materials are possible. Between FEP and ETFE, FEP may be preferred for certain applications since it is stable at high temperatures and is generally impervious to acids and other caustic chemicals, and is more flexible than ETFE.

The ribbon tubing 10 may be provided with upper and lower outwards facing longitudinal grooves 24a, 24b between neighboring pairs of lumens 12 for facilitating frangibility and separation of the lumens 12 from one another. The grooves 24a, 24b will typically be formed during the manufacturing process, e.g., either as a feature in a mold for molded tubing or a feature in a die, forming roll, or the like for extrusion. As shown in FIG. 3A, the grooves 24a, 24b may be relatively shallow. Alternatively, as shown in FIG. 3B, the grooves 24a, 24b may be deeper, with the lumens 12 being more distinct from one another. It should be noted that given a set wall thickness, a shorter pitch 22 results in the tubing shown in FIG. 3A, while a longer pitch results in the tubing shown in FIG. 3B. In either case, the sidewall 16 may be configured so that the lumens 12 are frangible by hand and/or by the use of a machine or device, e.g., a blade or other sharp instrument. As suggested by FIG. 2, the tubing 10 may be provided with the lumens 12 pre-separated from one another proximate one or both ends of the tubing 10.

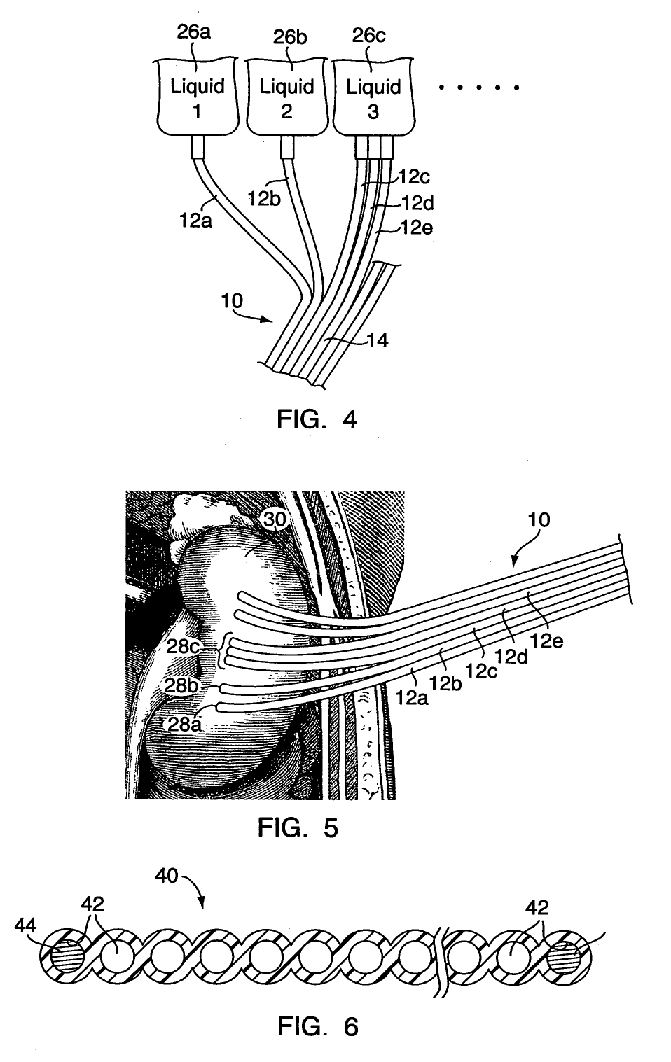

FIG. 4 shows the tubing 10 in use on the supply end. Here, a first lumen 12a is connected to a first liquid or other fluid source 26a, and a second lumen 12b is connected to a second fluid source 26b. In addition, three other lumens 12c-12e are connected to a third fluid source 26c. Assuming the lumen passageways are the same size, if each fluid source 26a-26c has the same source pressure, then each lumen 12a-12e will transfer fluid at the same flow rate. As such, to provide different volumes of fluids, all that is required is to combine some of the lumens 12 in parallel with a common source and destination. Thus, in FIG. 4, if each lumen 12a-12e admits a fluid at a flow rate of “X” given the same source pressure, then the three lumens 12c-12e connected in parallel will admit an effective flow rate of 3X. In FIG. 4, the lumens 12a, 12b, and 12c-12e are shown as being separated from one another (12c-12e remain connected) proximate the end of the tubing 10 by the fluid sources 26a-26c. As should be appreciated, this might be done for facilitating connection of the lumens to the fluid sources in cases where the fluid sources are spaced apart. However, the tubing 10 could be connected to multiple fluid sources without separating the lumens 12, provided the coupling(s) to the fluid sources were closely proximate to one another. As shown in FIG. 4, despite the lumens 12a-12e being partially separated from one another, this is only proximate the end of the tubing, and the lumens remain connected to one another away from the fluid sources 26a-26c. Thus, most of the tubing 10 remains unified, tangle-free, and easy to route and place in a laboratory, medical, or other setting.

FIG. 5 shows an example of the tubing 10 in use on the destination end. Here, lumen 12a is connected to one location 28a on a biological or other subject 30. The subject could be an organ or other body part, a chemical apparatus, a machine, or any other device or object with which tubing is used. Similarly, lumen 12b is connected to a different, second location 28b, and lumens 12c-12e are connected at a third location 28c. Although the tubing 10 has been indicated for use in delivering fluids between various fluid sources 26a-26c and a destination subject 30, the tubing 10 could also be used to simultaneously deliver fluids in both directions. For example, lumens 12c-12e could be used to deliver fluid to the subject 30 from a fluid source 26c, while lumen 12a could be used to draw in fluid from the subject 30 at the location 28a and to deliver the sampled fluid to a device for analysis or monitoring.

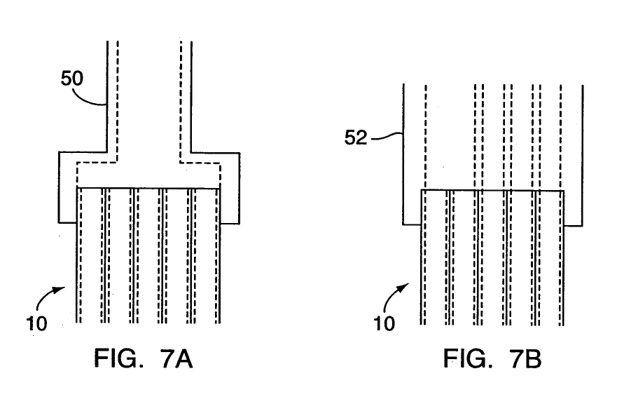

The tubing 10 may be connected to a source or destination using standard tube fittings or other connectors dimensioned to correspond to the shape and size of the tubing 10. As noted above, if the distal ends of some or all of the lumens are left connected together, they can be conveniently terminated into one mass, multi-lumen connector 50 (see FIG. 7A) that provides a single common connection (e.g., one fluid source for all the lumens), a connector that provides multiple connections (e.g., different fluid sources for the different lumens), or a connector 52 (see FIG. 7B) that provides a combination of the two.

The tubing 10 may be manufactured by molding, but more typically by extrusion. To form the passageways 18, the sidewall 16 may be extruded over a plurality of wire-like, longitudinal metal supports, each of which has a cross section corresponding to the desired cross section of the passageways 18. Once the polymer sidewall is set, the metal supports are stretched/elongated (typically by at least 25%) and then pulled axially away and out from the sidewall, leaving the passageways 18. If a forming roll is used as part of the extrusion process, adhesion between the supports and sidewall may be lowered by deepening the forming roll concavities that in combination define the outer periphery of the tubing 10.

The tubing 10 may take the form of non-stacked tubing. By “non-stacked” tubing, it is meant that not only are the lumens 12 laterally sequentially arranged in parallel to form a generally flat outer periphery 14, but that the tubing 10 only has lumens so arranged, and does not have any lumens dissimilarly arranged, e.g., lumens stacked atop one another.

An embodiment of the present invention may also be characterized as a length of tubing have an outer wall and a plurality of longitudinal interior walls connected to the outer wall, with the passageways being defined by the outer wall and interior walls. Here, the outer wall would be considered the portion of the tubing separating the passageways from the exterior of the tubing, and the interior walls would be considered the portion of the tubing separating the passageways from one another.

FIG. 6 shows an alternative embodiment of the ribbon tubing 40. Here, one or more of the passageways 42 would each be provided with a bendable support 44 extending down the length of the passageway. The bendable support 44 could be a small-diameter, generally stiff metal wire, i.e., a wire that maintains its shape but is capable of being easily bent. Such supports would allow the ribbon tubing 40 to be formed or bent into different configurations, shapes, or pathways, and would also help with rolls of the tubing remaining rolled up in storage and transportation. The supports could be provided as a byproduct of the manufacturing process, simply by leaving one or more of the above-described extrusion supports in place instead of removing them to form the passageways.

Since certain changes may be made in the above-described multi-lumen, miniature ribbon tubing, without departing from the spirit and scope of the invention herein involved, it is intended that all of the subject matter of the above description or shown in the accompanying drawings shall be interpreted merely as examples illustrating the inventive concept herein and shall not be construed as limiting the invention.

What is claimed is:

1. A length of tubing comprising:
a plurality of interconnected lumens each having a polymer sidewall and a hollow longitudinal fluid passageway, wherein the lumens are laterally sequentially arranged in parallel to form a generally flat outer periphery;
wherein the passageways have a maximum dimension of about 0.005 to about 0.050 inches.

2. The tubing of claim 1 wherein the sidewalls have a thickness of about 0.005 to about 0.015 inches.

3. The tubing of claim 1 wherein the lumens are integrally formed.

4. The tubing of claim 1 wherein the sidewalls are formed of at least one of FEP and ETFE.

5. The tubing of claim 1 wherein the lumens are longitudinally frangible from one another.

6. The tubing of claim 5 further comprising a plurality of first and second outwards-facing longitudinal sidewall grooves located between successive lumens.

7. The tubing of claim 1 wherein the passageways are round in cross section with a diameter of about 0.050 to about 0.005 inches.

8. The tubing of claim 1 wherein:
the sidewalls have a thickness of about 0.005 to about 0.015 inches;
the sidewalls are formed of at least one of FEP and ETFE; and
the lumens are longitudinally frangible from one another, with the ribbon tubing further comprising a plurality of first and second outwards-facing longitudinal sidewall grooves located between successive lumens.

9. The tubing of claim 1 wherein:
the ribbon tubing has first and second ends; and
at least some of the plurality of lumens are longitudinally separated from one another proximate the first and/or second ends.

10. The tubing of claim 1 further comprising:
a support lumen attached to at least one of said plurality of interconnected lumens and laterally sequentially arranged in parallel thereto to maintain the generally flat outer periphery of the tubing, said support lumen comprising a polymer sidewall and a bendable metal support coaxial with the sidewall and extending longitudinally along at least a portion of the sidewall.

11. The tubing of claim 1 comprising at least six of said lumens.

12. The tubing of claim 11 comprising at least twenty of said lumens.

13. The tubing of claim 1 wherein the tubing is non-stacked tubing.

14. A length of tubing comprising:
a polymer outer wall having a generally flat outer periphery;
a plurality of longitudinal interior walls connected to the outer wall; and
a plurality of interior passageways defined by the outer wall and interior walls, said passageways being parallel to and separated from one another by the interior walls, and said passageways being laterally successively arranged across the width of the outer wall, wherein the passageways have a maximum dimension of about 0.050 to about 0.005 inches.

15. The tubing of claim 14 wherein the outer wall and interior walls have a thickness of about 0.005 to about 0.015 inches.

16. The tubing of claim 14 wherein the outer walls and interior walls are integrally formed.

17. The tubing of claim 14 wherein the outer and interior walls are formed of at least one of FEP and ETFE.

18. The tubing of claim 14 wherein:
the outer and interior walls have a thickness of about 0.005 to about 0.015 inches;
the outer and interior walls are formed at least one of FEP and ETFE.

19. The tubing of claim 14 comprising at least 6 of said passageways.

20. The tubing of claim 19 comprising at least 20 of said passageways.

21. The tubing of claim 14 wherein the tubing is non-stacked tubing.

22. A length of tubing comprising:
a generally flat polymer tube structure; and
at least twenty longitudinal interior passageways in the polymer tube structure, said passageways being separate from one another and laterally successively arranged parallel to one another across the width of the polymer tube structure.

23. The tubing of claim 22 wherein the passageways have a maximum dimension of about 0.050 to about 0.005 inches.

24. The tubing of claim 23 wherein the distance between each passageway and an exterior of the polymer tube structure is from about 0.005 to about 0.015 inches.

25. A length of tubing comprising:
a generally flat polymer tube structure; and
a plurality of interior passageways in the polymer tube structure, said passageways being separate from one another and laterally successively arranged parallel to one another across the width of the polymer tube structure, wherein the passageways have a maximum dimension of about 0.050 to about 0.005 inches.
